(19) United States
(12) Patent Application Publication
(10) Pub. No.: US 2025/0281924 A1
(43) Pub. Date: Sep. 11, 2025

(54) TWO-PART CENTRIFUGAL TUBE

(71) Applicant: Maged Mikhail, Calgary (CA)

(72) Inventor: Maged Mikhail, Calgary (CA)

(21) Appl. No.: 18/598,473

(22) Filed: Mar. 7, 2024

(51) Int. Cl. B01L 3/00; G01N 1/40

(52) U.S. Cl. CPC B01L 3/5021; G01N 1/4077; G01N 2001/4088

(57) ABSTRACT

A two-part test tube with a removable filter is provided. The two-part test tube achieves filtration without a pump, yielding a near-dry substances above ashless paper filter. The two-part test tube includes an upper tube removably affixed to a lower tube. A filter receiving chamber is positioned at a lower end of the upper chamber and between the upper and lower tubes when connected. The filter receiving chamber is able to house a filter therein. When the two-part test tube is spun, the solution is housed in the upper tube and passes through the filter to the lower chamber. The filter captures the filtrates and is ready for analysis since it is also dried during the process. A vent disposed on a sidewall of the lower tube prevents formation of a vacuum or airlock, enabling continuous and unobstructed flow across the filter.

### BACKGROUND OF THE INVENTION

The present invention relates to a two-part centrifugal tube focusing on centrifugation and filtration. The two-part centrifugal tube comprises an upper tube portion removably connected to a lower tube portion, wherein the upper tube portion forms an upper compartment and the lower tube portion forms a lower compartment. The upper tube portion has an open upper end adapted to receive liquid into the upper compartment and a filter receiving chamber at the lower end thereof. The filter receiving chamber is a part of the upper tube and disposed between the upper compartment and the lower compartment and a filter is removably disposed within the filter receiving chamber.

Filtration, in the laboratory context, involves separating substances such as particles, molecules, precipitates, or solids from fluids through a medium. The filter's size and configuration determine what substances are retained when the solution is passed through the filter. Many filters utilize gravity or pressure differences to drive fluid flow through the filter. In some instances, pressure filters rely on external forces (such as compressed air) to achieve filtration. These pumps or pistons exert force to propel liquid through the filter.

In laboratory settings, filtration systems most commonly utilize pumps to drive the solution across the filter. However, these filtration systems introduce complexities. In many cases, filtration systems face design challenges, such as the accumulation of filtered material forming barriers and causing filter clogs. These issues are particularly pronounced in existing storage methods employing filtration systems with pumps. Moreover, various filtration techniques involving pumps present drawbacks. The need for additional equipment and the risk of clogs compromises the efficiency of these systems.

In view of these developments, there exists a need for centrifuge filtration. The present invention achieves centrifuge filtration through a two-part tube that houses the solution. Utilizing the inertial force generated by a centrifuge, the invention applies a centrifugal force to the solution, propelling it through the filter. When positioned in the centrifuge with the tubular body's long axis aligned along a radius and the filter end farther from the point of rotation, the centrifugal force efficiently pulls the solution or suspension through the filter, achieving superior filtration.

By introducing a two-part tube with filter for centrifugal filtration, the two-part tube provides an innovative and effective solution to the shortcomings of traditional filtration methods. The two-part tube introduces additional benefits such as enhanced simplicity and efficiency in laboratory procedures. This design minimizes the need for multiple machines, streamlining the centrifugation and filtration processes into a single, integrated step. The utilization of paper, porcelain, or plastic mesh within the upper tube not only improves filtration quality but also facilitates quantitative analysis, surpassing the limitations of solid filtration methods found in conventional designs. The simple connection and removable upper tube permit easy extraction of liquids, addressing challenges associated with existing storage methods. Moreover, the incorporation of a strategically positioned vent ensures optimal air ventilation, preventing the formation of airlocks and maintaining a consistent flow during the transition of the solution from the upper tube to the lower tube.

In light of the devices disclosed in the known art, it is submitted that the present invention substantially diverges in design elements and methods from the known art and consequently it is clear that there is a need in the art for an improvement in a two-part centrifugal tube that enables centrifugal filtration. In this regard the instant invention substantially fulfills these needs.

### SUMMARY OF THE INVENTION

In view of the foregoing disadvantages inherent in the known types of filtrations, the present invention provides a two-part centrifugal tube that enables centrifugal filtration. The test tube comprises an upper tube portion removably connected to a lower tube portion, wherein the upper tube portion forms an upper compartment, and the lower tube portion forms a lower compartment. The upper tube portion has an open upper end adapted to receive liquid into the upper compartment and a filter receiving chamber at the lower end thereof. The filter receiving chamber is disposed at the lower end of the upper compartment and a filter is removably disposed within the filter receiving chamber.

It is an objective of the present invention to provide an embodiment of the two-part test tube with a simplified structure for easy separation of the upper and lower tubes. The design prioritizes a mechanism that facilitates removal of the upper assembly with minimal risk of sample spillage or contamination.

It is an objective of the present invention to provide an embodiment of the two-part test tube optimizes the integration of centrifugation and filtration processes within a single, user-friendly apparatus.

It is an objective of the present invention to provide an embodiment of the two-part test tube having a removable upper tube having a filter receiving chamber that receives a removable filter. The receiving chamber enhances the structural efficiency of the tube to allow for superior filtration and facilitating both qualitative and quantitative analysis.

It is an objective of the present invention to provide an embodiment of the two-part test tube to facilitate easy separation of the upper and lower tubes. The design aims to simplify the extraction process, allowing for removal of the upper tube and extraction of the filter while minimizing the risk of sample spillage or contamination.

It is an objective of the present invention to provide an embodiment of the two-part test tube to achieve a dry filter after spinning. The innovative design ensures that the filtration process results in a filter that is nearly dry above the ashless paper, enhancing the quality of filtrate and eliminating the need for additional drying steps in laboratory procedures.

It is an objective of the present invention to provide an embodiment of the two-part test tube that provides for consistent filtration across the filter via an air vent. The vent ensures efficient air ventilation, preventing airlocks and maintaining a consistent flow during the transition of the solution.

It is therefore an object of the present invention to provide a new and improved two-part test tube that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the two-part test tube.

FIG. 2A shows an overhead view of an embodiment of the filtration paper of the filter.

FIG. 2B shows a perspective view of an embodiment of the mesh portion of the filter.

FIG. 3 shows a close-up cross-sectional view of one embodiment of the upper tube and lower tubes of the two-part test tube.

FIG. 4 shows a perspective view of an embodiment of the two-part test tube with a solution in the upper compartment prior to filtration.

FIG. 5 shows a perspective view of an embodiment of the two-part test tube with a solution in the lower compartment after filtration.

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be used for integration of centrifugation and filtration processes within a single two-part test tube. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment”, “second embodiment”, or “third embodiment” does not necessarily refer to the same embodiment. References to “solution” in the context of the two-part test tube's filtration system encompasses a wide range of liquid mixtures, suspensions, and solutions with diverse chemical compositions and properties, including but not limited to aqueous solutions, organic solvents, biological samples, chemical reagents.

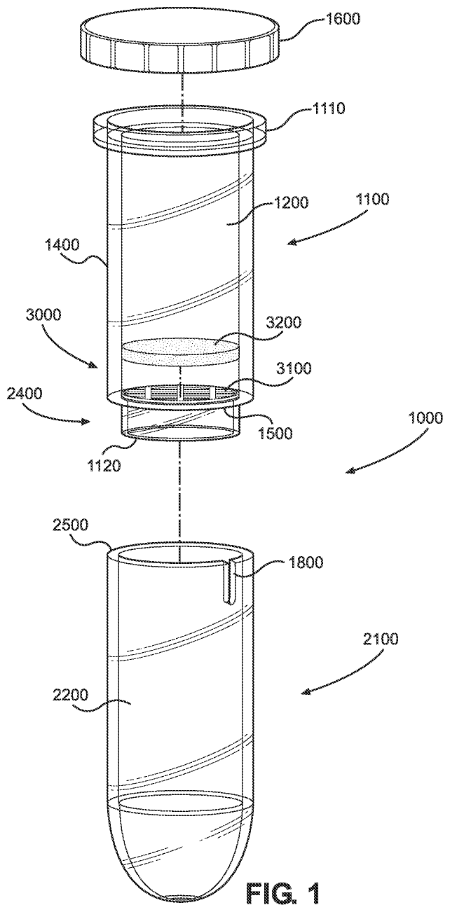

Referring now to FIG. 1, there is shown an exploded view of an embodiment of the two-part test tube. The two-part test tube 1000 provides a device for simultaneous filtrations and centrifuging. The two-part test tube 1000 comprises an upper tube portion 1100 removably connected to a lower tube portion 2100, wherein the upper tube portion 1100 forms an upper compartment 1200 and the lower tube portion 2100 forms a lower compartment 2200. The upper tube portion 1100 has an open upper end 1110 adapted to receive liquid into the upper compartment 1200 and a filter receiving chamber 1500 at the lower end 1120 thereof. The filter receiving chamber-is formed as part of the lower end of the upper tube. In an alternative embodiment, the filter receiving chamber is removable and forms a separable part placed between the lower end of the upper tube and upper end of the lower tube.

In the shown embodiment, the upper and lower tube portions 1100, 2100 are cylindrical and hollow. The lower tube portion 2100 includes a closed lower end that provides for the housing of a solution or sample. As used herein, “solution” or “sample” are used interchangeably and denote any material. In alternate embodiments, the test tube portions comprise any suitable cross sectional shape configured to align and secure to one another.

In the shown embodiment, a vent 1800 is disposed on a sidewall of the in the upper part of the lower tube 2100 which prevents formation of a vacuum or airlock, enabling continuous and unobstructed flow across the filter 3000. The vent 1800 is positioned above a fill line and in some embodiments includes a purifier to prevent contamination of the sample. In the illustrated embodiment, the vent 1800 is a single aperture. The upper end of the upper tube portion 1100 is sealed with a removable cap 1600. The cap 1600 is configured to secure closure of the upper compartment and form a seal therewith. This cap 1600 is designed to snugly fit the open upper end, forming an effective seal to prevent any leakage during liquid transfer or centrifugal processes.

In one embodiment, the exterior surface of the upper tube portion is equipped with a visual volume indicator. This indicator may consist of calibrated markings or graduated lines, providing a convenient reference for estimating the amount of liquid contained in the upper compartment.

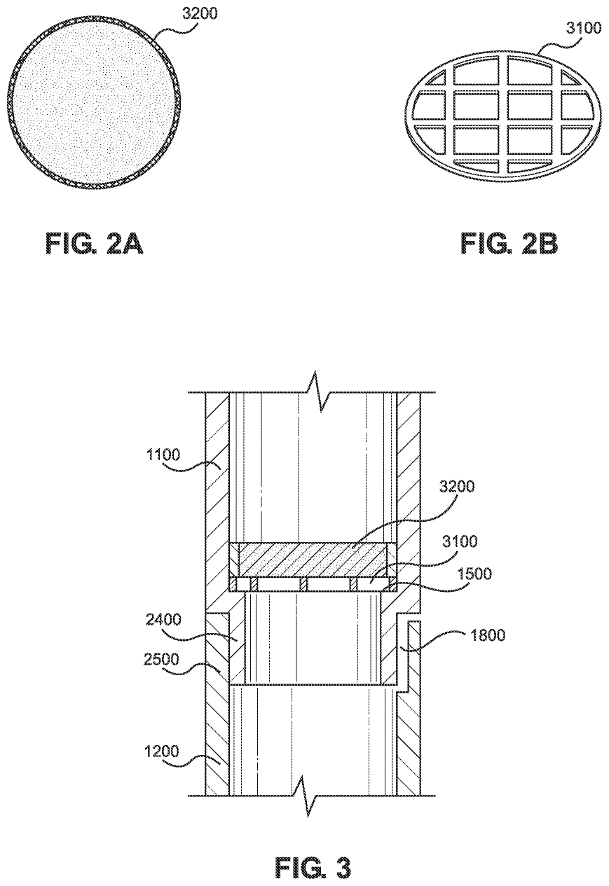

Referring now to FIGS. 2A, 2B, and 3, there is shown an overhead view of an embodiment of the filtration paper of the filter, a perspective view of the mesh portion of the filter, and a close-up cross-sectional view of one embodiment of the upper tube and lower tubes of the two-part test tube, respectively. The filter 3000 comprises filtration paper 3200 that is removable from the assembly and is sized to be seated atop the mesh portion 3100. In the shown embodiment, the filtration paper and mesh portion 3100, 3200 are circular and flat. However, in alternative embodiments, the filter may vary in size, shape, and material. The filter 3000 may be formed as conical, cylindrical, or irregular shapes based on specific filtration needs. This flexibility ensures adaptability to diverse laboratory applications.

In one embodiment, the filter 3000 comprises ashless paper. Ashless paper is a specialized filter material that is manufactured to minimize the ash content typically found in standard filter papers. This type of filter paper is made from high-purity cellulose fibers, often derived from plant sources such as cotton or wood pulp. In the shown embodiment, a mesh portion 3100 of the filter 3000 supports the removable ashless paper filter 3200. In one embodiment, the mesh portion 3100 is a part of the lower end of the upper tube 1100 to support the filtration paper or disc positioned thereon.

In the shown embodiment, the upper and lower portions 1100, 2100 are securely connected via a frictional fitting interface. A sidewall 2500 of the lower tube portion 2100 is received within a shoulder 2400 of the end of the upper tube portion 1100, which is formed from a narrower position of the upper tube portion 1100. The shoulder 2400 is positioned at the lower end of the upper tube 1100 and aligns the interior side of the sidewalls of both compartments to be coextensive. The frictional fitting facilitates a tight and stable connection, preventing unintentional separation during handling or the centrifugation process. In other embodiments, other fasteners or fastening methods are used to join the upper and lower tube portions 1100, 2100. For example, some fasteners include, but are not limited to: threaded fasteners, snap-fit mechanisms, latching systems, bayonet mounts, magnetic connections, locking tabs or clips, bayonet joints, and adhesive bonding.

In one exemplary use, a user can connect the upper and lower portions 1100, 2100 by aligning the corresponding ends and applying a moderate force to engage the frictional fit. Conversely, for separation, a controlled force is applied to disconnect the upper and lower tube portions 1100, 2100 without undue difficulty. The arrangement of the joint is aligned with the direction of the centrifugal force making it unlikely that the joint with separate in use.

In one embodiment, the filter receiving chamber 1500 is situated at the lower end of the upper tube portion 1100. The filter receiving chamber 1500 is sized to accommodate and retain the filter 3000 to ensuring no leaking around the filter during the centrifugal processes. The filter 3000 incorporates a removable component that receives the ashless paper to increase the ease of use and maintenance. In the shown embodiment, the filter 3000 comprises the ashless paper filter paper 3200 that is positioned on top of the mesh portion 3100, wherein the mesh portion 3100 is formed as part of the lower end of the upper tube. This removable component comprises a mesh or screen to allow the user to replace or clean the filter as desired. Moreover, this configuration provides for reusability and extended lifespan of the test tube.

The centrifugal filtration process facilitated by the two-part test tube 1000, with its ashless paper filter 3000 yields a clear supernatant and dry filter 3000 in a single step. This indicates that the test tube 1000 effectively separated the suspended particles from the liquid sample during centrifugation, leaving behind a transparent and clarified liquid in the upper compartment (supernatant). The term “dry” occurs when filtrate on the filter exhibits a notable lack of excess liquid.

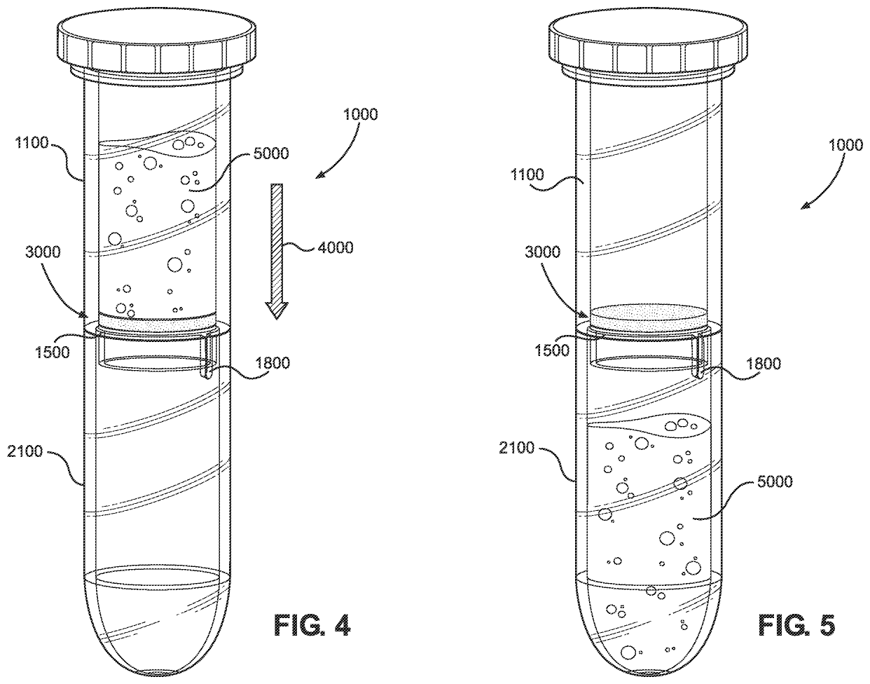

Referring now to FIGS. 4 and 5, there is shown a perspective view of an embodiment of the two-part test tube with a solution in the upper compartment prior to filtration and in the lower compartment after filtration, respectively. In one exemplary embodiment, the present method of filtering a solution sample comprises assembling the two-part test tube, consisting of the lower assembly 2100 for sample containment and the upper assembly 1100 with a removable filter 3000. The filter 3000 is received within the filter receiving compartment of the upper assembly 1100, and the upper assembly 1100 is secured to the lower assembly 2100. The solution is carefully loaded into the upper tube of the test tube, ensuring that the sample does not exceed the specified capacity. The assembled two-part test tube is loaded in the centrifuge, aligning the long axis of the tubular body along a radius of the centrifuge rotor. The test tube is oriented so that the lower tube is farther away from the point of rotation than the upper end.

The centrifuge is spun to apply an inertial force, or “centrifugal force,” on the solution within the test tube. As the rotor spins, the centrifugal force acts on the solution sample, pushing it through the filter in the upper assembly and into the lower tube. The paper filter and mesh 3200, 3100 within the upper assembly efficiently captures particles, molecules, or solids larger than the specified filter “cut-off.” The nearly dry filtrate passes through the filter, separating from the retained substances. Simultaneously, the vent allows for efficient air ventilation, preventing the formation of airlocks during the solution transition from the upper tube to the lower tube. Once the desired centrifugation and filtration duration has elapsed, the centrifuge ceases the application of centrifugal force. The upper tube is now disconnected from the lower tube, utilizing the simplified connection mechanism. The removable upper tube allows for easy extraction of the filter without disturbing the filtered solution in the lower tube. The solution sample is now both filtered, and the components of the sample separated. The filter can be taken for further processing for qualitative or quantitative analysis.

In one embodiment, a centrifugal filtration system is provided. The centrifugal filtration system integrates the two-part test tube to filter and centrifuge a sample at the same time. The centrifugal filtration system comprises a two-part testing tube forming a liquid container for containing a sample. The two-part testing tube 1000 comprises an upper tube portion 1100 removably connected to a lower tube portion 2100, wherein the upper tube portion forms an upper compartment, and the lower tube portion forms a lower compartment. The upper tube portion 1100 has an open upper end that is adapted to receive the liquid sample 5000 into the upper compartment and a filter receiving chamber 1500 at the lower end thereof. The filter receiving chamber 1500 is-a part of the upper tube portion or can be disposed between the upper compartment and the lower compartment 1100, 2100. A filter 3000 is removably disposed within the filter receiving chamber 1500. A vent 1800-is a part of the upper end of the lower tube and configured to facilitate air flow during liquid transfer between the upper and lower compartments. A centrifugal source 4000 is configured to spin the two-part test tube and sample. Pre-spin, the sample 5000 is retained in the upper chamber in a first configuration, the sample 5000 is transferred across the filter 3000 to the lower chamber after centrifugal spinning in a second configuration. In the shown embodiment of FIG. 4, the sample 5000 is initially disposed in the upper tube portion 1100 prior to the spinning and filtering. As shown in FIG. 5, the sample 5000, less the filtrate held in the filter 3000, is in the lower tube portion 2100.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A two-part testing tube forming a liquid container for containing a sample, comprising:
an upper tube portion removably connected to a lower tube portion, wherein the upper tube portion forms an upper compartment and the lower tube portion forms a lower compartment;
the upper tube portion having an open upper end adapted to receive liquid into the upper compartment and a filter receiving chamber at the lower end thereof, wherein the filter receiving chamber is disposed between the upper compartment and the lower compartment;
a filter removably disposed within the filter receiving chamber.

2. The two-part testing tube of claim 1, further comprising a vent configured to facilitate air flow during liquid transfer between the upper and lower compartments.

3. The two-part testing tube of claim 2, wherein the vent is disposed on the upper lower tube portion.

4. The two-part testing tube of claim 2, wherein the vent is disposed at the upper end of the upper lower tube portion.

5. The two-part testing tube of claim 1, wherein the lower tube portion is transparent and configured to provide visual observation of the sample during centrifugal filtration.

6. The two-part testing tube of claim 1, wherein the upper tube portion and the lower tube portion are configured for frictional engagement such that a watertight seal is formed therebetween.

7. The two-part testing tube of claim 1, wherein the filter receiving chamber is disposed at the lower end of the upper tube portion.

8. The two-part testing tube of claim 1, wherein the filter receiving chamber is defined by a sidewall of the upper tube portion.

9. The two-part testing tube of claim 8, wherein the filter is sized to fill the filter receiving chamber.

10. The two-part testing tube of claim 9, wherein the upper tube portion, the filter received within the filter receiving chamber, and the lower tube portion are coaxially aligned.

11. The two-part testing tube of claim 10, wherein an interior side of the upper portion sidewall and an interior side of a sidewall of the lower tube portion are coextensive.

12. The two-part testing tube of claim 1, wherein the filter within the filter receiving chamber is a replaceable filter element selected from a group comprising paper, plastic mesh, porcelain, or a combination thereof.

13. The two-part testing tube of claim 1, wherein the upper tube portion includes a cap for forming a seal when connected to the upper end of the upper tube portion, the cap configured to prevent leakage of the sample.

14. The two-part testing tube of claim 1, wherein the filter is adapted to retain the sample in the upper chamber prior to centrifugal spinning, and transfer the sample across the filter to the lower chamber after centrifugal spinning.

15. A centrifugal filtration system, comprising:
a two-part testing tube forming a liquid container for containing a sample, the two-part testing tube comprising:
an upper tube portion removably connected to a lower tube portion, wherein the upper tube portion forms an upper compartment and the lower tube portion forms a lower compartment;
the upper tube portion having an open upper end adapted to receive the sample into the upper compartment and a filter receiving chamber at the lower end thereof, wherein the filter receiving chamber is disposed between the upper compartment and the lower compartment;
a filter removably disposed within the filter receiving chamber;
a vent configured to facilitate air flow during liquid transfer between the upper and lower compartments;
a centrifugal source configured to spin the two-part test tube and sample;
wherein the sample is retained in the upper chamber prior to centrifugal spinning in a first configuration;
wherein the sample is transferred across the filter to the lower chamber after centrifugal spinning in a second configuration.

16. The centrifugal filtration system of claim 15, wherein the vent is disposed on the upper lower tube portion.

17. The two-part testing tube of claim 16, wherein the upper tube portion and the lower tube portion are configured for frictional engagement such that a watertight seal is formed therebetween.

18. The two-part testing tube of claim 16, wherein the filter receiving chamber is disposed at the lower end of the upper tube portion.

19. The two-part testing tube of claim 16, wherein the upper tube portion, the filter received within the filter receiving chamber, and the lower tube portion are coaxially aligned and wherein an interior side of the upper portion sidewall and an interior side of a sidewall of the lower tube portion are coextensive.

20. The two-part testing tube of claim 16, wherein the filter is adapted to retain the sample in the upper chamber prior to centrifugal spinning, and transfer the sample across the filter to the lower chamber after centrifugal spinning.
